(19) United States
(12) Patent Application Publication
(10) Pub. No.: US 2023/0301289 A1
(43) Pub. Date: Sep. 28, 2023

(54) Fishing lure box

(71) Applicant: Haijun YANG, Fujian (CN)

(72) Inventor: Haijun YANG, Fujian (CN)

(21) Appl. No.: 17/701,717

(22) Filed: Mar. 23, 2022

(51) Int. Cl. A01K 97/06

(52) U.S. Cl. CPC A01K 97/06

(57) ABSTRACT

The utility model discloses a lure box, comprising a box body, a box cover and a handle. The outer side wall of the box cover is provided with a mounting block, a vertical portion is provided with a rotating shaft, and the outer side wall of the rotating shaft and the mounting block are provided with concave-convex limiting structure, the box cover and the box body are both protruding with limit rods at the vertical portion, the two limit rods are arranged opposite each other up and down, the rotating shaft is located between the two limit rods, and the vertical portion is provided with a accommodating groove, the accommodating groove is provided with a sliding inlet, and the two sliding inlets are respectively located outside the front and rear sides of the rotating shaft.

### BACKGROUND OF THE INVENTION

The utility model relates to fishing utensils, in particular to a lure box.

Lure is a method of fishing, a method of imitating weak creatures to trigger off attack by a big fish. The lure box is an important auxiliary hook in fishing activities, which is mainly used to store the tools used for fishing and the harvested fish. The structure of the existing lure box generally includes a box body and a box cover, one side of the box cover is hinged on the box body, the box body is provided with a handle for lifting, and the left and right arms of the handle are hinged at the outside of the upper left and right sides of the box body. When carrying, lift the handle upwards, the handle is in an upright state, and the whole lure box can be lifted and carried. When hooking fish, the handle should be placed directly on the front side or rear side of the box, open the box cover to place items in the box or take them from the box. This kind of lure box, because there is no support point after the box cover is opened, the box cover is inclined at a certain angle after it is opened, and cannot be placed straight, so that the bottom surface of the box cover cannot be used as a placing platform, and the handle will shake when in use, and it is not easy to carry the lure box.

In view of this, the inventor of the present invention has conducted in-depth research on the above-mentioned problems, resulting in this case.

### BRIEF SUMMARY OF THE INVENTION

The purpose of this utility model is to provide a lure box to solve the problems in the prior art that the box cover cannot be placed straight after being opened and cannot be used as a placing platform and the handle will shake and affect the carrying of the lure box.

In order to achieve the above purpose, the utility adopts the following technical solutions:

A lure box, comprises a box body, a box cover and a handle, the box cover is hinged on the box body in a way that can be turned up and down, and the handle has a horizontal part extending along the left and right direction of the box body and a vertical portion at the left and right ends of the horizontal part, the vertical portion and the horizontal part are integrally formed, and the two vertical portions are corresponding to the left and right sides of the box cover, and the lower end of the vertical portion is hinged together with the box cover; the outer side wall of the box cover corresponding to the lower end of the vertical portion is provided with a mounting block, and the side of the vertical portion facing the mounting block is provided with a rotating shaft that extends into the mounting block, the outer side wall of the rotating shaft and the mounting block are provided with a concave-convex limiting structure for guiding the rotating shaft to extend into the mounting block and limiting the rotating shaft to the mounting block, the lower end of the vertical portion extends outside the upper part of the box body, and the box cover and the box body both have limit rods positioned at the vertical portion, the two limit rods are set up and down correspondingly, the rotating shaft is located between the two limit rods, and the vertical portion is provided with accommodating grooves for the two limit rods to slide inside and to be limited to accommodate respectively, the accommodating groove is provided with a sliding inlet for the limit rod to slide into the accommodating groove along the front and rear directions, and the two sliding inlets are respectively located outside the front and rear sides of the rotating shaft.

The lower end of the vertical portion is integrally formed with a mounting plate extending downwardly, and the opposite side of the mounting plate and the box body is used as the mounting surface, the upper and lower ends of the mounting surface of the mounting plate are respectively provided with strip-shaped arc plates extending along the front-rear direction of the box body, and a hollow circular block between the two arc-shaped plates is protruded on the mounting surface of the mounting plate, the hollow circular block is protruded with a cylindrical rod that protrudes out of the hollow circular block and extends horizontally in the direction of the box body, the cylindrical rod is the described rotating shaft, one side wall of the mounting block facing the vertical portion is provided with a circular mounting hole for the cylindrical rod to be inserted into the interior, the outer side wall of the free end of the cylindrical rod is protruded with a square bump, an extending port that matches with the square bump and communicates with the mounting blockis opened at the edge of the hole of the mounting block corresponding to the circular mounting hole, and the extending port and the square bump constitute the concave-convex limiting structure. There is a distance between the hollow circular block and the two arc-shaped plates, and this distance is the accommodating groove. The top front side and the bottom rear side of the hollow circular block are provided with baffles with closed intervals, and the two baffles are dislocated up and down, opposite to each other front and rear, the end of the distance opposite to the baffle is the sliding inlet.

The strip-shaped arc plate and the limit rod above the hollow circular block are respectively the upper arc-shaped plate and the upper limit rod, the lower bottom surface of the upper arc-shaped plate is protruded downward with a strip-shaped convex strip extending in the left-right direction, the bottom surface of the strip-shaped convex strip is a convex arc surface that protrudes downward, the top surface of the limit rod is concave with a concave arc groove extending in the left-right direction and leading to the outside of the end of the limit rod, the strip-shaped convex strip is embedded in the concave arc groove, the top surface of the upper limit rod located on the front and rear sides of the concave arc groove is an inclined surface inclined downward, and the inclined directions of the two inclined surfaces are arranged opposite to each other.

The lower part of the front side of the box body is concavely provided with an accommodating chamber, the accommodating chamber leads downward to the outside of the bottom surface of the box body, the accommodating chamber is provided with a flip box that is erected in the accommodating chamber and can be turned downward, the flip box has a body whose rear side is open and a cover which is covered on the rear side of the body, the rear side of the bottom surface of the body protrudes downwardly with a first hinge shaft, the front part of which is located below the body and the rear part is located at the bottom rear side of the box body and extends in the left-right direction, the front of the bottom side of the cover is provided with a second hinge shaft whose rear part is located under the cover and the front side is located under the body and closely fits with the first hinge shaft, the first hinge shaft and the second hinge shaft are connected in series through a pin shaft, the upper front side of the cover and the top surface of the box body are fastened together, the lower left and right outer side walls of the body are respectively protruded with lugs, and the left and right inner groove walls of the accommodating chamber are both provided with positioning holes for the lugs to extend inside, the minimum distance between the positioning holes is smaller than the maximum distance between the two lugs and greater than the maximum distance between the two lugs, the maximum distance between the two positioning holes is greater than the maximum distance between the two lugs, the lower part of the rear inner groove wall of the accommodating chamber is protruded forwards with the supporting convex plates which are arranged at opposite intervals from left to right, a rotating shaft is connected between the two supporting convex plates, the bottom surface of the body is concavely provided with a recess leading to the rear side of the box body, the two supporting convex plates are embedded in the recess, the inner top surface of the recess is protruded downward with a mounting block embedded between the two supporting convex plates, the rear side of the mounting block is concavely forward provided with a through hole penetrating in the left-right direction, the rotating shaft slides into the through hole, and the bottom surface of the cover is concavely upward provided with a through recess for the rear of the mounting block to pass through.

The box body is further provided with a strap, and the left and right sides of the box body are respectively integrally formed with a side frame body with a hollow structure surrounded by a front plate, a back plate, an upper top plate and a side plate, the side plate is arranged away from the box body, the side plate of the side frame body is provided with a through port that communicates with the hollow chamber of the side frame body, and the upper top plate of the side frame body is provided with an belt-piercing hole for the strap to extend inside, the upper hole wall of the side plate located in the through port is concavely upwards provided with a positioning groove, the side frame body is provided with a belt buckle, the belt buckle is closely matched with the side plate, and the buckle is provided with a perforation for the strap to pass through, the buckle is extended with a block which is located in the port and overlaps with the upper hole wall of the port, the top surface of the block protrudes upward with a limit piece extending into the positioning groove, the block is provided with a pull hole for pulling the block downward, the length of the block in the vertical direction is shorter than the length of the port in the vertical direction.

The box cover has an upper box cover and a lower box cover, the upper box cover is a hollow shell with an open bottom surface, and the rear edge of the upper box cover is hinged with the upper part of the rear side of the lower box cover, a zipper cloth bag is placed in the hollow chamber of the upper box cover, the lower box cover is a hollow shell with an open top surface, the front side of the upper box cover and the front side of the lower box cover are buckled and connected, the upper part of the lower box cover is hinged with two flaps that can be flipped up, the two flaps are closely matched with each other on the left and right, with the opposite side of the two flaps as the opposite side, and the top surface of the opposite side of one of the two flaps is recessed with an extending groove, and the top surface of the opposite side of the other opening and closing cover is extended with a grasping lug suspended in the extending groove, the rear side of the lower box cover and the box body are hinged together in a way that can be turned upward, and the bottom surface of the lower box cover is a plane.

The side plates of the side frame body are provided with mounting holes, the mounting holes have expanding holes in a circular structure and reducing holes located below the expanding holes and communicated with the expanding holes, the reducing hole is a strip hole extending in the up and down direction, the strip hole has a concave arc structure, there are optional parts outside the side frame body, and the optional part facing the part of the mounting hole is protruded with a protruding shaft extending in the left and right direction, the protruding shaft has a rod portion and a head part, the outer diameter of the rod portion matches the diameter of the reducing hole, the head part is a circular head, the diameter of the head part matches the diameter of the expanding hole.

The optional part is a rod rack, and the rod rack is a hollow frame with three sides open and surrounded by a front plate body, a rear plate body and a side plate body, the side plate is arranged away from the frame body, the front plate body and the rear plate body are both provided with the protruding shafts, a bottom plate is provided in the bottom of the rod rack, and the front and rear ends of the bottom plate close to the side frame body are respectively protruded with a cylindrical shaft, and the bottom of the rod rack is concavely provided with an embedded recess for the cylindrical shaft to be embedded in.

The optional part is a cup holder, the cup holder has a back plate and a bottom bracket, the side of the back plate facing the side frame is protruded with the protruding shaft, and the back plate is located between the bottom bracket and the side frame body, the bottom bracket is arranged horizontally in the left-right direction, the side of the bottom bracket close to the back plate is hinged with the lower end of the back plate, and the bottom bracket has an accommodating cavity for the back plate to be accommodated inside, the upper end of the back plate is hinged with a circular cup ferrule that can be turned downward.

The optional part is a storage box, the storage box has a hollow box body and a cover arranged on the hollow box body, the hollow box body is provided with a shoulder strap, a built-in square box that can be movably taken out is arranged in the hollow box body, and the side of the hollow box body facing the side frame body has the protruding shaft.

The optional part can also be a tool box, the tool box is erected, the tool box has a body part and a cover, the body part and the side frame body are attached, the side of the body part attached to the side frame body is provided with the protruding shaft, the cover is on the side of the body part away from the side frame body, and the side of the cover facing away from the body part is provided with a mounting bump, and the mounting bump is connected with the protruding shaft on the body part, the top surface of the mounting bump is concave with a strip-shaped groove extending in the up-down direction, and the side of the mounting bump facing away from the cover is provided with an extension opening that communicates with the strip-shaped groove and leads to the top surface of the mounting bump, the inner diameter of the extension opening matches the outer diameter of the rod portion of the protruding shaft, and the width of the groove in the front and rear directions of the strip-shaped groove matches the diameter of the head part of the protruding shaft.

The utility model relates to a lure box. When applied, the two limit rods of the box cover are clamped in the two accommodating grooves correspondingly, so that the vertical portion cannot swing back and forth relative to the box cover and stays in a fixed upright state. When the box cover is open and turned down, the box cover is in a straight state, the fixed handle will be in an upright state supporting the box cover. At this time, the box cover can be used as a placing platform, which is easy for users to operate fishing. The fishing operation platform is added. The fixed handle keeps the lure box from shaking when carried, which is convenient for carrying.

### BRIEF DESCRIPTION OF THE DRAWINGS

FIG. 1 is the perspective view of the utility model;

FIG. 2 is the perspective view of the box body in the utility model;

FIG. 3 is the perspective view of the box cover and the handle in the utility model;

FIG. 4 is a perspective view of the utility model with a rod holder;

FIG. 5 is a perspective view of the utility model with a cup holder;

FIG. 6 is a perspective view of the utility model with a storage box;

FIG. 7 is a perspective view of the utility model with a tool box;

FIG. 8 is a perspective view of the handle in the utility model;

FIG. 9 is a perspective view of the box cover in the utility model.

### DETAILED DESCRIPTION OF THE INVENTION

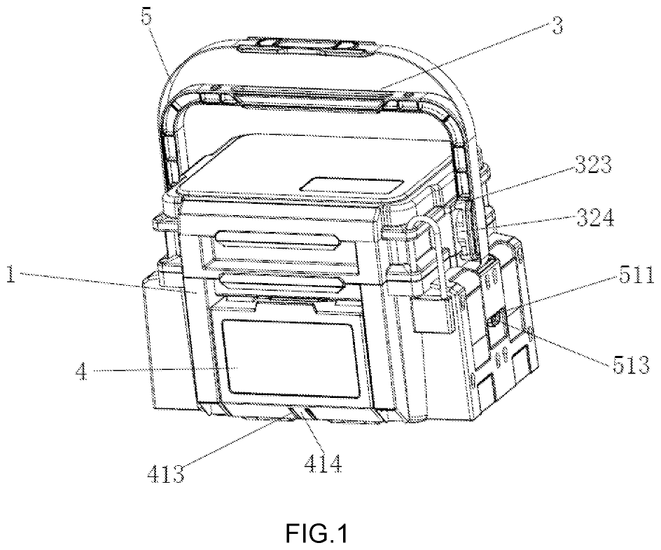

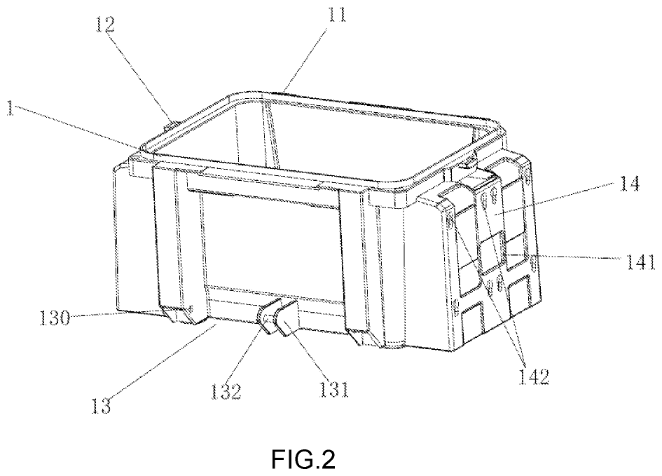

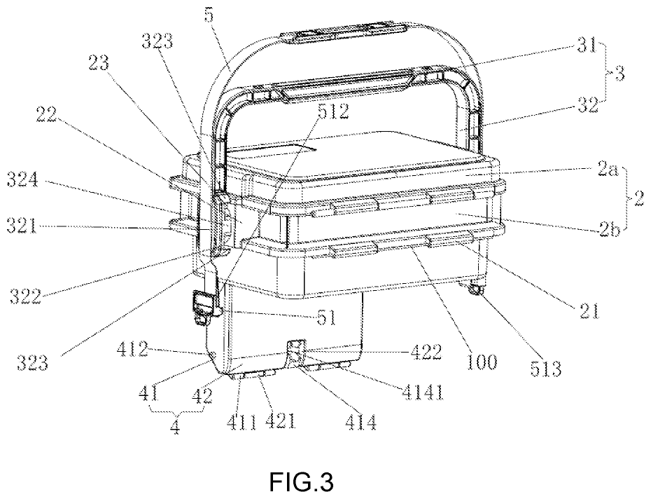

A lure box of the present utility model, as shown in FIGS. 1-3, comprises a box body 1, a box cover 2 and a handle 3, the rear side of the box cover 2 is hinged on the rear side of the top surface of the box body 1, i.e., the rear side of the top surface of the box body 1 is protruded with rear hinge shafts 11 extending in the left and right direction, and several rear hinge shafts 11 are provided. A lower hinge shaft 21 between the two rear hinge shafts 11 is protruded on the rear side of the box cover 2, and each rear hinge shaft and the lower hinge shaft 21 are connected in series through a pin 100. Using the pin 100, the box cover 2 can be turned over and opened around the pin 100.

The handle 3 has a horizontal part 31 extending along the left and right direction of the box body 1 and a vertical portion 32 at the left and right ends of the horizontal part. The vertical portion 32 and the horizontal part 31 are integrally formed, and the two vertical portions 32 are corresponding to the outside of the left and right sides of the box cover 2, and the lower end of the vertical portion 32 is hinged together with the box cover 2; preferably, the outer side wall of the box cover 2 is provided with a mounting block 22 corresponding to the lower end of the vertical portion 32. The mounting block 22 is preferably a hollow structure. The side of the vertical portion 32 facing the mounting block 22 is provided with a rotating shaft 321 that extends into the mounting block 22. The outer side wall of the rotating shaft 321 and the mounting block 22 are provided with a concave-convex limiting structure for guiding the rotating shaft to extend into the mounting block 22 and limiting the rotating shaft to the mounting block 22. The vertical portion 32 extends to the upper end of the box body 1, and the box cover 2 is provided with a limit rod 23 protruding from the vertical portion 32, and the box body 1 has a limit rod 12 positioned at the vertical portion 32, the two limit rods are arranged opposite each other up and down, and the rotating shaft 321 is located between the two limit rods. The vertical portion 32 is provided with accommodating grooves for the limit rods 23 to slide inside and to be limited to accommodate respectively (not shown in the figure), and the accommodating groove is provided with a sliding inlet for the limit rod to slide into the accommodating groove along the front and rear directions, and the two sliding inlets are respectively located outside the front and rear sides of the rotating shaft.

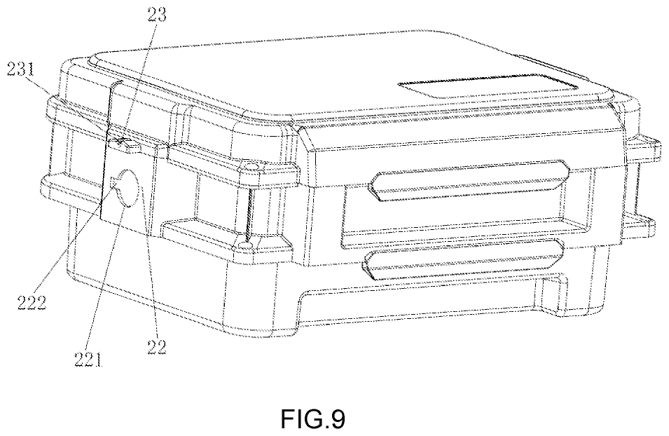

As shown in FIGS. 8 and 9, the lower end of the vertical portion 32 is integrally formed with a mounting plate 322 extending downwardly, the mounting plate 322 has an elliptical structure extending in the up-down direction, and the upper portion of the mounting plate 322 is located at outside of the lower part of the box cover and the lower part is located at outside the upper part of the box body. The side of the mounting plate 322 opposite to the box body 1 is used as the mounting surface. The mounting surface and the lower ends of the mounting plate 322 are respectively protruded with strip-shaped arc plates 323 extending along the front-rear direction of the box body, and the arc openings of the two arc-shaped plates are set opposite to each other. The mounting surface of the mounting plate 322 is protruded with a hollow circular block 324 between the two arc-shaped plates 323, and the hollow circular block 324 is protruded with a cylindrical rod extending out of the hollow circular block and extending horizontally in the direction of the box body 1. One side wall of the mounting block 22 facing the vertical portion is provided with a circular mounting hole 221 for the cylindrical rod to be tightly fitted and inserted into the interior, the cylindrical rod is the shaft 321, and there is a distance between the hollow circular block and the two arc-shaped plates, and this distance is the accommodating groove. The top front side and the bottom rear side of the hollow circular block 324 are provided with baffles 325 with closed intervals, and the two baffles are dislocated up and down, opposite to each other front and rear. The distance at the end opposite to the baffle is the sliding inlet. That is, there is an upper distance between the upper strip-shaped arc plate 323 and the upper top surface of the hollow circular block 324, and the rear side of the top surface of the hollow circular block 324 is erected with the baffle 325 connected to the upper strip-shaped arc-shaped plate 323, and the front end port at the upper distance is the sliding inlet for the upper limit rod 23 to slide in. Similarly, there is a lower distance between the lower strip-shaped arc plate 323 and the lower top surface of the hollow circular block 324. The front side of the bottom surface of the hollow circular block 324 is erected with the baffle 325 connected to the lower strip-shaped arc plate 323, and the rear end port at the lower distance is the sliding inlet for the lower limit rod 12 to slide in. The outer side wall of the free end of the cylindrical rod is protruded with a square bump 326, and an extending port 222 that matches with the square bump 326 and communicates with the hollow cavity of the mounting block 22 is opened at the edge of the hole of the mounting block 22 located in the circular mounting hole 221, the extending port 222 is communicated with the circular mounting hole 221, and the extending port and the square bump constitute the concave-convex limiting structure. In application, the square bump 326 of the vertical portion is positioned relative to the extending port 222, so that the rotating shaft 321 can extend into the circular mounting hole 221, and then rotate the rotating shaft 321, the square bump 326 and the extending port 222 are dislocated, so the rotating shaft 321 cannot be pulled out from the circular mounting hole 221, at the same time, the limit rod 23 is positioned relative to the upper distance, and the limit rod 12 is positioned relative to the lower distance. When the rotating shaft 321 rotates, the limit rod 23 slides into the upper distance from the front opening of the upper distance and is restricted by the upper baffle 325 and cannot move backward, the limit rod 12 slides into the lower distance from the rear opening of the lower distance and is restricted by the lower baffle 325 and cannot move forward. At this time, the whole handle 3 is in a fixed upright state, the lifting box 1 is not easy to shake, and it is convenient to carry. When the box cover 2 is opened and turned to be in a straight state, the handle 3 is just below the box cover 2, which plays a fixed and support role for the box cover 2. At this time, the inner bottom surface of the box cover 2 can be used as an operating platform, which is easy for users to operate fishing, adding a fishing operating platform, and the whole structure is simple and easy to manufacture.

The lure box of this utility, it is preferable that the strip-shaped arc plate above the hollow circular block 324 is used as the upper arc-shaped plate, and the lower bottom surface of the upper arc-shaped plate is protruded downward with a strip-shaped convex strip 3231 extending in the left-right direction. The bottom surface of the strip-shaped convex strip 3231 is a convex arc surface that protrudes downward. The top surface of the limit rod 23 is concave with a concave arc groove 231 extending in the left-right direction and leading to the outside of the end of the limit rod 23. The strip-shaped convex strip 3231 is embedded in the concave arc groove 231, and the top surface of the limit rod 23 located on the front and rear sides of the concave arc groove 231 is an inclined surface inclined downward, and the inclined directions of the two inclined surfaces are arranged opposite to each other. The combination of the strip-shaped convex strip and the concave arc groove makes the erection of the vertical portion on the box cover 2 more stable, and the cooperation of the arc and the inclined surface makes the rotation of the vertical portion smoother.

The lure box of this utility, it is preferable that the lower part of the front side of the box body 2 is concavely provided with an accommodating chamber 13, the accommodating chamber 13 leads downward to the outside of the bottom surface of the box body 1, the accommodating chamber 13 is provided with a flip box 4 that is erected in the accommodating chamber 13 and can be turned downward. The flip box 4 has a body 41 whose rear side is open and a cover 42 which is covered on the rear side of the box body. The rear side of the bottom surface of the body 41 protrudes downwardly with a first hinge shaft 411, the front part of which is located below the box body and the rear part is located at the bottom rear side of the box body and extends in the left-right direction. Several first hinge shafts 411 are provided. The first hinge shafts 411 are arranged at intervals along the left-right direction, and the front of the bottom side of the cover 42 is provided with a second hinge shaft 421 whose rear part is located under the box cover and the front side is located under the box body and closely fits with the first hinge shaft. Several second hinge shafts 421 are provided correspondingly. A second hinge shaft 421 is sandwiched between the two first hinge shafts 411, and each first hinge shaft 411 and each second hinge shaft 421 are connected in series through a pin shaft (not shown in the figure). The cover can be opened by using the first hinge shaft and the second hinge shaft. The upper front side of the cover and the top surface of the box body are fastened together by a fastener. The fastening method of the cover and the box body are well known, which will not be repeated here. The lower left and right outer side walls of the body 41 are respectively protruded with lugs 412, and the left and right inner groove walls of the accommodating chamber 13 are both provided with positioning holes 130 for the lugs to extend into. The minimum distance between the positioning holes 130 is smaller than the maximum distance between the two lugs 412 and greater than the maximum distance between the two lugs 412. The maximum distance between the two positioning holes 130 is greater than the maximum distance between the two lugs. By defining the dimensions of the two lugs and the two positioning holes, it can be realized that the body 41 is provided with the supporting convex plates 131 which are arranged at opposite intervals from left to right and extend forwards on the lower part of the rear inner groove wall of the accommodating chamber 13, a rotating shaft 132 is connected between the two supporting convex plates 131. The bottom surface of the body 41 is concavely provided with a recess 413 leading to the rear side of the body 41. The two supporting convex plates 131 are embedded in the recess 413, that is, the supporting convex plate 131 is in close contact with the inner wall of the recess 413, and the inner top surface of the recess 413 is protruded downward with a mounting block 414 embedded between the two supporting convex plates, the rear side of the mounting block 414 is concavely forward provided with a through hole 4141 penetrating in the left-right direction, the rotating shaft 132 slides into the through hole 4141, and the bottom surface of the cover 42 is concavely upward provided with a through recess 422 for the rear of the mounting block 414 to pass through; during application, the flip box 4 can be turned downward by using the lugs 412. After the flip box 4 is flipped downward, it is limited by the supporting convex plate 131 to support the flip box 4, so that the flip box 4 is in a straight state, to ensure the normal use of the flip box 4, and the use of the flip box 4 can increase the storage capacity of the entire lure box.

The lure box of this utility, it is preferable that the box body 1 is also provided with a strap 5, and the left and right sides of the box body 1 are respectively integrally formed with a side frame body 14 with a hollow structure surrounded by a front plate, a back plate, an upper top plate and a side plate, the side plate of the side frame body 14 is provided with a through port 141 that communicates with the hollow chamber of the side frame body, and the upper top panel of the side frame body 14 is provided with an belt-piercing hole (not shown in the figure) for the strap 5 to extend into the inside, the upper hole wall of the side plate located in the through port is concavely upwards provided with a positioning groove (not shown in the figure), and the side frame body 14 is provided with a belt buckle 51. The belt buckle 51 is closely matched with the side plate, and the buckle 51 is provided with a perforation (not shown in the figure) for the strap to pass through. The buckle 51 is extended with a block 511 which is located in the port and overlaps with the upper hole wall of the port. The top surface of the block 511 protrudes upward with a limit piece 512 extending into the positioning groove. The block 511 is provided with a pull hole 513 for pulling the block 511 downward. The length of the block 511 in the vertical direction is shorter than the length in the vertical direction of the port, so that the block 511 has a pull-down space. Initially, the limit piece 512 is in the positioning groove, and the buckle 51 cannot be moved upward due to the restriction of the port. At this time, the strap 5 is closely arranged along the handle, so that the strap 5 will not be pulled arbitrarily; when the strap 5 needs to be used, put your finger into the pull hole 513 and pull down the block 511 to make the limit piece 512 come out of the positioning groove into the port, at this time the buckle 51 can be completely moved into the side frame body 14, the strap 5 can be pulled upward without restriction, so that the strap 5 can be pulled out to adjust the length to realize the function of carrying the lure box on the shoulder.

The lure box of this utility, it is preferable that the box cover 2 has an upper box cover 2a and a lower box cover 2b, the upper box cover 2a is a hollow shell with an open bottom surface, and the rear edge of the upper box cover 2a is hinged with the upper part of the rear side of the lower box cover. The hinged method of the upper box cover and the lower box cover is the same as the hinged method of the box cover and the box body. The lower hinge shaft 21 is arranged on the rear edge of the lower box cover, and a zipper cloth bag (not shown in the figure) is placed in the hollow chamber of the upper box cover 2a. The lower box cover 2b is a hollow shell with an open top surface, the bottom surface of the lower box cover is flat, and the front side of the upper box cover and the front side of the lower box cover are buckled and connected. The fastening method of the upper box cover and the lower box cover adopts the fastening method of the box body and box cover in the traditional plastic box, which is not repeated here as it is a well-known technology. The upper part of the lower box cover 2b is hinged with two flaps that can be flipped up. The two flaps are closely matched with each other on the left and right, with the opposite side of the two flaps as the opposite side, and the top surface of the opposite side of one of the two flaps is recessed with an extending groove, and the top surface of the opposite side of the other opening and closing cover is extended with a grasping lug suspended in the extending groove; in application, the use of the upper box cover and the lower box cover can increase the overall accommodation, and the arrangement of the zipper cloth bag increases the accommodation space, and the use of two flaps can seal the accommodation space in the lower box cover, and cooperate with the gripping lugs and the extending grooves to facilitate the opening and closing of the cover.

The lure box of this utility, it is preferable that the side plates of the side frame body 14 are provided with mounting holes 142, there are several mounting holes 142, and the mounting holes 142 have expanding holes in a circular structure and reducing holes located below the expanding holes and communicated with the expanding holes. The reducing hole is a strip hole extending in the up and down direction. The strip hole has a concave arc structure. There are optional parts outside the side frame body 14, and the optional part facing the part of the mounting hole 142 is protruded with a protruding shaft extending in the left and right direction. The protruding shaft has a rod portion and a head part. The outer diameter of the rod portion matches the diameter of the reducing hole. The head part is a circular head. The diameter of the head part matches the diameter of the expanding hole. When installing, the head part extends into the expanding hole and then moves down to make the rod portion snap into the reducing hole and cooperates with the head part to restrict the convex shaft in the side frame body 14 to realize the fixation of the optional parts. During disassembly, pull up to move the rod portion upwards into the expanding hole, and then the head part can be pulled out of the side frame body 14 to realize the disassembly of the optional parts.

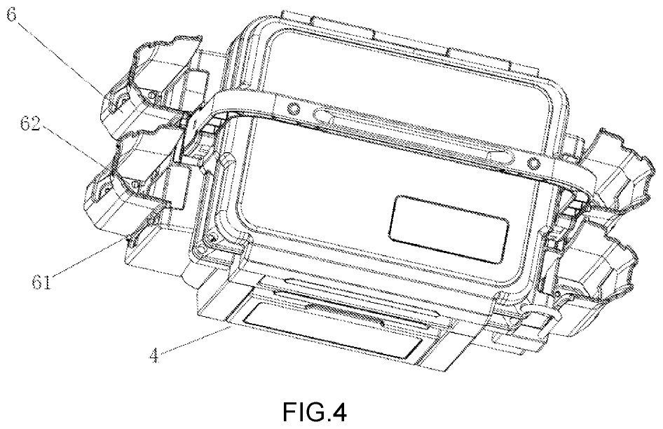

As shown in FIG. 4, the optional part can be a rod rack 6, which is a hollow frame with three sides open and surrounded by a front plate body, a rear plate body and a side plate body. The sides of the front plate body and the rear plate body facing the frame body 14 are protruded with protruding shafts 61, and the entire rod rack 6 can be installed on the box body 1 by using the protruding shafts 61. A bottom plate 62 is provided in the bottom of the rod rack 6, and the front and rear ends of the bottom plate 62 close to the side frame body are respectively protruded with a cylindrical shaft extending in the front-rear direction, and the bottom of the rod rack 6 is concavely provided with an embedded recess for the cylindrical shaft to be embedded in, that is, the front plate body and the rear plate body close to the side frame body is concavely provided with an arc-shaped groove, and the arc-shaped groove is the embedded recess. The bottom plate can be turned upward by using the cylindrical shaft of the bottom plate, so that the rod rack 6 is convenient for placing the fishing rod, and the arc-shaped groove is used to facilitate the disassembly and assembly of the bottom plate 62.

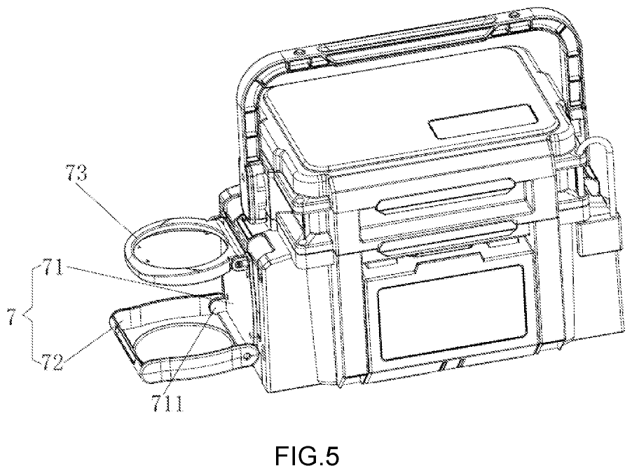

As shown in FIG. 5, the optional part can be a cup holder 7, the cup holder 7 has a back plate 71 and a bottom bracket 72, the side of the back plate 71 facing the side frame 14 is protruded with the above-mentioned protruding shaft, and the back plate 71 is located between the bottom bracket and the side frame body, the bottom bracket 72 is arranged horizontally in the left-right direction, the side of the bottom bracket 72 close to the back plate is hinged with the lower end of the back plate, and the bottom bracket has an accommodating cavity for the back plate to be accommodated inside, that is, the bottom bracket 72 has a front side surface, a rear side surface, a lower bottom surface and a side surface, and the front and rear sides of the lower end of the back plate 71 are respectively protruded with hinge lugs 711 extending into the bottom bracket 72 and matching with the front side surface and the rear side surface of the bottom bracket. The hinge lug and the bottom bracket are hinged together by the pin shaft, the upper end of the back plate 71 is hinged with a circular cup ferrule 73 that can be turned down, and the hinged method of the circular cup ferrule 73 and the back plate 71 is the same as the hinge method of the back plate and the bottom bracket, when used, the cup can be placed by using the bottom bracket and the circular cup ferrule. When not in use, the bottom bracket 72 is folded upward, and the circular cup ferrule 73 can be accommodated in the bottom bracket 72, which does not occupy space and is convenient to carry.

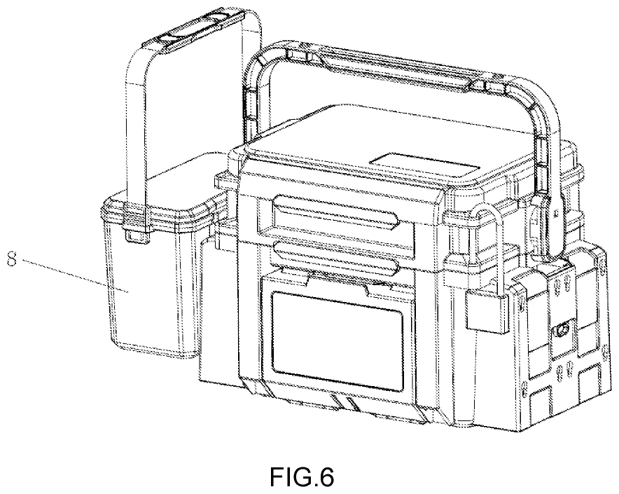

As shown in FIG. 6, the optional part can be a storage box 8, the storage box 8 has a hollow box body and a cover arranged on the hollow box body, the storage box 8 is an existing box body, and the hollow box body is provided with a shoulder strap 81, a built-in square box that can be movably taken out is arranged in the hollow box body, and the side of the hollow box body facing the side frame body has the protruding shaft, and the storage box 8 can be placed on the box body 1 by using this protruding shaft. On the one hand, the storage box 8 can be used to facilitate the separate carrying of local fishing utensils, increase the flexibility of use, and on the other hand, increase the storage space, and the setting of the built-in square box makes the storage box a double-layer structure, which is convenient for storage, the setting of this storage box 8 is suitable for Chinese citizens to use for close-range travelling and fishing.

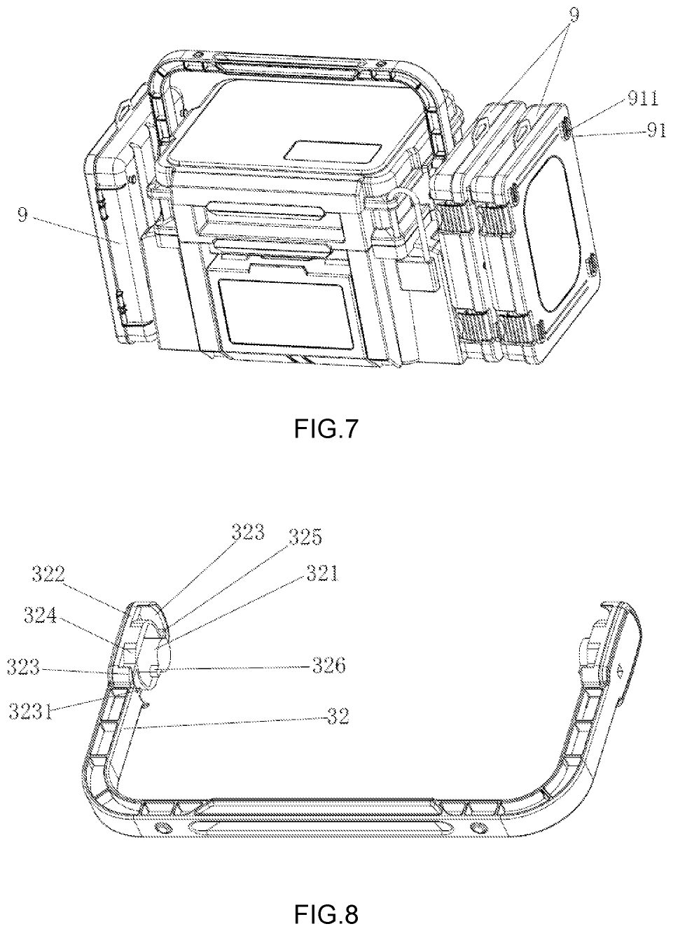

As shown in FIG. 7, the optional part can also be a tool box 9, the tool box 9 is erected, the tool box 9 has a body part and a cover, the tool box 9 is a well-known body part, and the side of the body part attached to the side frame body is provided with the protruding shaft, the cover is on the side of the body part away from the side frame body, and the side of the cover facing away from the body part is provided with a mounting bump 91, and the mounting bump 91 is connected with the protruding shaft on the body part. The top surface of the mounting bump 91 is concave with a strip-shaped groove 911 extending in the up-down direction, and the side of the mounting bump 91 facing away from the cover is provided with an extension opening that communicates with the strip-shaped groove and leads to the top surface of the mounting bump (not shown in the figure), the inner diameter of the extension opening matches the outer diameter of the rod portion of the protruding shaft, and the width of the groove in the front and rear directions of the strip-shaped groove matches the diameter of the head part of the protruding shaft. In this way, several tool boxes 9 can be stacked on each side of the body part by using the extension opening and the strip-shaped groove, and the use is more flexible.

What is claimed is:

1. A lure box, comprises a box body, a box cover and a handle, the box cover is hinged on the box body in a way that can be turned up and down, and the handle has a horizontal part extending along the left and right direction of the box body and a vertical portion at the left and right ends of the horizontal part, the vertical portion and the horizontal part are integrally formed, and the two vertical portions are corresponding to the left and right sides of the box cover, and the lower end of the vertical portion is hinged together with the box cover; it is characterized in that: the outer side wall of the box cover corresponding to the lower end of the vertical portion is provided with a mounting block, and the side of the vertical portion facing the mounting block is provided with a rotating shaft that extends into the mounting block, the outer side wall of the rotating shaft and the mounting block are provided with a concave-convex limiting structure for guiding the rotating shaft to extend into the mounting block and limiting the rotating shaft to the mounting block, the lower end of the vertical portion extends outside the upper part of the box body, and the box cover and the box body both have limit rods positioned at the vertical portion, the two limit rods are set up and down correspondingly, the rotating shaft is located between the two limit rods, and the vertical portion is provided with accommodating grooves for the two limit rods to slide inside and to be limited to accommodate respectively, the accommodating groove is provided with a sliding inlet for the limit rod to slide into the accommodating groove along the front and rear directions, and the two sliding inlets are respectively located outside the front and rear sides of the rotating shaft.

2. A lure box according to claim 1, characterized in that the lower end of the vertical portion is integrally formed with a mounting plate extending downwardly, and the opposite side of the mounting plate and the box body is used as the mounting surface, the upper and lower ends of the mounting surface of the mounting plate are respectively provided with strip-shaped arc plates extending along the front-rear direction of the box body, and a hollow circular block between the two arc-shaped plates is protruded on the mounting surface of the mounting plate, the hollow circular block is protruded with a cylindrical rod that protrudes out of the hollow circular block and extends horizontally in the direction of the box body, the cylindrical rod is the described rotating shaft, one side wall of the mounting block facing the vertical portion is provided with a circular mounting hole for the cylindrical rod to be inserted into the interior, the outer side wall of the free end of the cylindrical rod is protruded with a square bump, an extending port that matches with the square bump and communicates with the mounting block is opened at the edge of the hole of the mounting block corresponding to the circular mounting hole, and the extending port and the square bump constitute the concave-convex limiting structure. There is a distance between the hollow circular block and the two arc-shaped plates, and this distance is the accommodating groove. The top front side and the bottom rear side of the hollow circular block are provided with baffles with closed intervals, and the two baffles are dislocated up and down, opposite to each other front and rear, the end of the distance opposite to the baffle is the sliding inlet.

3. A lure box according to claim 2, characterized in that the strip-shaped arc plate and the limit rod above the hollow circular block are respectively the upper arc-shaped plate and the upper limit rod, the lower bottom surface of the upper arc-shaped plate is protruded downward with a strip-shaped convex strip extending in the left-right direction, the bottom surface of the strip-shaped convex strip is a convex arc surface that protrudes downward, the top surface of the limit rod is concave with a concave arc groove extending in the left-right direction and leading to the outside of the end of the limit rod, the strip-shaped convex strip is embedded in the concave arc groove, the top surface of the upper limit rod located on the front and rear sides of the concave arc groove is an inclined surface inclined downward, and the inclined directions of the two inclined surfaces are arranged opposite to each other.

4. A lure box according to claim 1, characterized in that the lower part of the front side of the box body is concavely provided with an accommodating chamber, the accommodating chamber leads downward to the outside of the bottom surface of the box body, the accommodating chamber is provided with a flip box that is erected in the accommodating chamber and can be turned downward, the flip box has a body whose rear side is open and a cover which is covered on the rear side of the body, the rear side of the bottom surface of the body protrudes downwardly with a first hinge shaft, the front part of which is located below the body and the rear part is located at the bottom rear side of the box body and extends in the left-right direction, the front of the bottom side of the cover is provided with a second hinge shaft whose rear part is located under the cover and the front side is located under the body and closely fits with the first hinge shaft, the first hinge shaft and the second hinge shaft are connected in series through a pin shaft, the upper front side of the cover and the top surface of the box body are fastened together, the lower left and right outer side walls of the body are respectively protruded with lugs, and the left and right inner groove walls of the accommodating chamber are both provided with positioning holes for the lugs to extend inside, the minimum distance between the positioning holes is smaller than the maximum distance between the two lugs and greater than the maximum distance between the two lugs, the maximum distance between the two positioning holes is greater than the maximum distance between the two lugs, the lower part of the rear inner groove wall of the accommodating chamber is protruded forwards with the supporting convex plates which are arranged at opposite intervals from left to right, a rotating shaft is connected between the two supporting convex plates, the bottom surface of the body is concavely provided with a recess leading to the rear side of the box body, the two supporting convex plates are embedded in the recess, the inner top surface of the recess is protruded downward with a mounting block embedded between the two supporting convex plates, the rear side of the mounting block is concavely forward provided with a through hole penetrating in the left-right direction, the rotating shaft slides into the through hole, and the bottom surface of the cover is concavely upward provided with a through recess for the rear of the mounting block to pass through.

5. A lure box according to claim 1, characterized in that the box body is further provided with a strap, and the left and right sides of the box body are respectively integrally formed with a side frame body with a hollow structure surrounded by a front plate, a back plate, an upper top plate and a side plate, the side plate is arranged away from the box body, the side plate of the side frame body is provided with a through port that communicates with the hollow chamber of the side frame body, and the upper top plate of the side frame body is provided with an belt-piercing hole for the strap to extend inside, the upper hole wall of the side plate located in the through port is concavely upwards provided with a positioning groove, the side frame body is provided with a belt buckle, the belt buckle is closely matched with the side plate, and the buckle is provided with a perforation for the strap to pass through, the buckle is extended with a block which is located in the port and overlaps with the upper hole wall of the port, the top surface of the block protrudes upward with a limit piece extending into the positioning groove, the block is provided with a pull hole for pulling the block downward, the length of the block in the vertical direction is shorter than the length of the port in the vertical direction.

6. A lure box according to claim 1, characterized in that the box cover has an upper box cover and a lower box cover, the upper box cover is a hollow shell with an open bottom surface, and the rear edge of the upper box cover is hinged with the upper part of the rear side of the lower box cover, a zipper cloth bag is placed in the hollow chamber of the upper box cover, the lower box cover is a hollow shell with an open top surface, the front side of the upper box cover and the front side of the lower box cover are buckled and connected, the upper part of the lower box cover is hinged with two flaps that can be flipped up, the two flaps are closely matched with each other on the left and right, with the opposite side of the two flaps as the opposite side, and the top surface of the opposite side of one of the two flaps is recessed with an extending groove, and the top surface of the opposite side of the other opening and closing cover is extended with a grasping lug suspended in the extending groove, the rear side of the lower box cover and the box body are hinged together in a way that can be turned upward, and the bottom surface of the lower box cover is a plane.

7. A lure box according to claim 5, characterized in that the side plates of the side frame body are provided with mounting holes, the mounting holes have expanding holes in a circular structure and reducing holes located below the expanding holes and communicated with the expanding holes, the reducing hole is a strip hole extending in the up and down direction, the strip hole has a concave arc structure, there are optional parts outside the side frame body, and the optional part facing the part of the mounting hole is protruded with a protruding shaft extending in the left and right direction, the protruding shaft has a rod portion and a head part, the outer diameter of the rod portion matches the diameter of the reducing hole, the head part is a circular head, the diameter of the head part matches the diameter of the expanding hole.

8. A lure box according to claim 7, characterized in that the optional part is a rod rack, and the rod rack is a hollow frame with three sides open and surrounded by a front plate body, a rear plate body and a side plate body, the side plate is arranged away from the frame body, the front plate body and the rear plate body are both provided with the protruding shafts, a bottom plate is provided in the bottom of the rod rack, and the front and rear ends of the bottom plate close to the side frame body are respectively protruded with a cylindrical shaft, and the bottom of the rod rack is concavely provided with an embedded recess for the cylindrical shaft to be embedded in.

9. The road box according to claim 7, characterized in that the optional part is a cup holder, the cup holder has a back plate and a bottom bracket, the side of the back plate facing the side frame is protruded with the protruding shaft, and the back plate is located between the bottom bracket and the side frame body, the bottom bracket is arranged horizontally in the left-right direction, the side of the bottom bracket close to the back plate is hinged with the lower end of the back plate, and the bottom bracket has an accommodating cavity for the back plate to be accommodated inside, the upper end of the back plate is hinged with a circular cup ferrule that can be turned downward.

10. A lure box according to claim 7, characterized in that the optional part is a storage box, the storage box has a hollow box body and a cover arranged on the hollow box body, the hollow box body is provided with a shoulder strap, a built-in square box that can be movably taken out is arranged in the hollow box body, and the side of the hollow box body facing the side frame body has the protruding shaft.

11. A lure box according to claim 7, characterized in that the optional part can also be a tool box, the tool box is erected, the tool box has a body part and a cover, the body part and the side frame body are attached, the side of the body part attached to the side frame body is provided with the protruding shaft, the cover is on the side of the body part away from the side frame body, and the side of the cover facing away from the body part is provided with a mounting bump, and the mounting bump is connected with the protruding shaft on the body part, the top surface of the mounting bump is concave with a strip-shaped groove extending in the up-down direction, and the side of the mounting bump facing away from the cover is provided with an extension opening that communicates with the strip-shaped groove and leads to the top surface of the mounting bump, the inner diameter of the extension opening matches the outer diameter of the rod portion of the protruding shaft, and the width of the groove in the front and rear directions of the strip-shaped groove matches the diameter of the head part of the protruding shaft.
